(19) United States
(12) Patent Application Publication
(10) Pub. No.: US 2007/0047074 A1
(43) Pub. Date: Mar. 1, 2007

(54) Apparatus for selective control of intensity and filtering of illumination

(76) Inventors: Richard E. Feinbloom, New York, NY (US); Kenneth Braganca, Floral Park, NY (US); Matthew Kenyon, Nesconset, NY (US)

Correspondence Address: PLEVY & HOWARD & DARCY P.C., P.O. BOX 226, Fort Washington, PA, 19034, US

(21) Appl. No.: 11/212,132

(22) Filed: Aug. 25, 2005

(51) Int. Cl. G02B 21/00

(52) U.S. Cl. 359/380

(57) ABSTRACT

A device for selectively controlling illumination from a source that emits illumination along an optical path toward an output has an intensity control apparatus for selectively controlling the intensity of illumination at the output; a filter adapted to be selectively disposed in the optical path; and a unitary mechanical user input for controlling the intensity control apparatus and for, when the intensity is at a maximum, permitting selective disposition of the filter in the optical path.

### FIELD OF THE INVENTION

This invention is in the field of illumination, and has application in fields including illumination for medical and dental use.

### BACKGROUND

In illumination systems for medical and dental use, a housing has a light source that provides illumination to a port in the housing. The port is adapted to receive a coupling on a flexible fiber optic cable for attachment to a headset, for example. Prior art illumination systems include a knob for adjustment of illumination intensity. A filter arrangement, with a selectively interposed filter, is often provided in prior art systems so as to permit illumination of photocurable dental cement, while filtering out radiation in the range that cures the cement. A separate control, such as a switch is provided to move the filter in the path of the illumination beam.

Dental professionals employing these systems frequently adjust the intensity and the filter while looking at the patient's mouth. Often, the user has adjusted the position of his/her head and the headset in order to illuminate the tooth or other area of the mouth of interest, while adjusting the illumination intensity. In order to activate the filter, the user must move fingers from the knob to the switch. The user cannot turn and look at the light source without losing the alignment of the headset. Thus, the user must fumble for the switch without moving his/her head. This process is inconvenient at best, and frequently results in the dental professional moving, and losing the proper illumination of the tooth of interest.

### SUMMARY OF THE INVENTION

In one embodiment of the invention, a device for selectively controlling illumination from a source that emits illumination along an optical path toward an output has an intensity control apparatus for selectively controlling the intensity of illumination at the output; a mechanism for selectively disposing a filter in the optical path; and a unitary mechanical user input for controlling the intensity control apparatus and for, when the intensity as controlled by the intensity control apparatus is at a maximum, causing the filter disposition mechanism to dispose the filter in the optical path.

In another embodiment, an apparatus for providing illumination at an output port, has a lamp for providing illumination along an optical path to an output; an intensity control apparatus for selectively controlling the intensity of illumination at the output; a filter adapted to be selectively disposed in the optical path; and a unitary mechanical user input for controlling said intensity control apparatus and for, when the intensity as controlled by the intensity control apparatus is at a maximum, permitting selective disposition of said the in the optical path.

In another embodiment, a device for selectively controlling illumination from a source that emits illumination along an optical path toward an output includes an opaque member movably mounted to selectively block the optical path so as to selectively control the intensity of illumination at the output; a filter supported on an arm, the arm being movably mounted so that said filter may be selectively disposed in the optical path; and a unitary mechanical user input operatively connected to the opaque member and the arm, for selectively moving the opaque member and the filter for controlling the intensity of illumination at the output and, when the intensity is at a maximum, permitting selective disposition of the filter in the optical path.

### BRIEF DESCRIPTION OF THE FIGURES

The advantages, nature, and various additional features of the invention will appear more fully upon consideration of the illustrative embodiments now to be described in detail in connection with accompanying drawings where like reference numerals identify like elements throughout the drawings:

FIG. 1 is a schematic illustration of an illumination system incorporating an illumination control device according to an embodiment of the invention.

FIG. 2A is a plan view of an exemplary intensity control device for use in an illumination system of FIG. 1, in a first orientation.

FIG. 2B is a plan view of the intensity control device of FIG. 2A in a second orientation.

FIG. 2C is a plan view of the intensity control device of FIG. 2A in a third orientation.

FIG. 3 is a side plan view showing a mechanism for selectively disposing a filter in an optical path in an illumination system of FIG. 1.

FIG. 4A is a plan view of the mechanism of FIG. 3, in a first orientation.

FIG. 4B is a plan view of the mechanism of FIG. 3, in a second orientation.

FIG. 4C is a plan view of the mechanism of FIG. 3, in a third orientation.

FIG. 5 is a schematic diagram showing the various portions of the travel path of a unitary mechanical user input in an embodiment of the invention.

### DETAILED DESCRIPTION

It is to be understood that the figures and descriptions of the present invention have been simplified to illustrate elements that are relevant for a clear understanding of the present invention, while eliminating, for purposes of clarity, many other elements found in typical illuminating systems. However, because such elements are well known in the art, and because they do not facilitate a better understanding of the present invention, a discussion of such elements is not provided herein. The disclosure herein is directed to all such variations and modifications known to those skilled in the art.

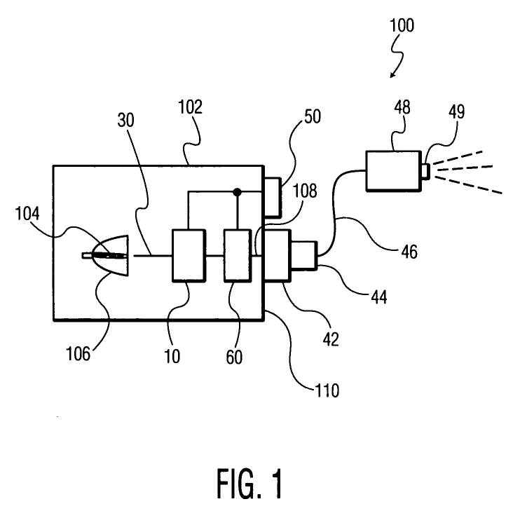

Referring now to FIG. 1, a device for selectively controlling illumination from a source that emits illumination along an optical path toward an output will now be described. The device will be described with reference to an implementation in a system particularly adapted for use by dentists or surgeons for illumination of the mouth, skin or tissues. However, the device of the invention may be implemented in other applications.

In FIG. 1, an illumination system 100 is illustrated. Illumination system 100 has a base unit 102. Base unit 102 includes a lamp 104, which emits light focused by elliptical reflector 106 to optical path 30. Lamp 104 may be any suitable source of light for the particular application. By way of non-limiting example, lamp 104 may be a metal halide bulb, a xenon bulb, a tungsten halogen bulb, or a mercury bulb. As an alternative to elliptical reflector 106, one or more lenses may be provided. Optical path 30 extends from lamp 104 to output 108. Optical path 30 defines a beam of light, which will customarily have a circular cross-section, although other cross-sections may be provided, depending, for example, on the optics of provided lenses and reflectors. The optical path proceeds through a connector 42, into endpiece 44, through optical cable 46, to headset 48. Lensing 49 on headset 48 illuminates the area of interest.

In FIG. 1, intensity control apparatus 10 for selectively controlling the intensity of illumination at the output 108 is illustrated schematically as deployed in an illumination system 100. Intensity control apparatus 10 is operatively coupled to unitary mechanical user input 50. Manipulation of unitary mechanical user input 50 causes adjustment of intensity control apparatus 10, as explained in greater detail below. Unitary mechanical user input 50 is also operatively coupled to a mechanism 60 for selectively disposing a filter in the optical path 30. Unitary mechanical user input 50 may include any input that is operable by the manipulation thereof in any degree of freedom. Unitary mechanical user input may include a rotatably mounted knob, or an arm or lever responsive to sliding, pushing, or pulling, or rotation about a pivot, or a combination of such motions. Unitary mechanical user input 50 may be operatively coupled to intensity control apparatus 10 and filter disposition mechanism 60 through mechanical linkages, or through one or more electromechanical, electrical or electronic devices or interfaces. Unitary mechanical user input 50 has is adapted to be manipulated by one or more fingers of the user. As will be explained in greater detail below, unitary mechanical user input 50

Intensity control apparatus 10 selectively permits passage of illumination along optical path 30, between maximum passage of illumination and minimum passage of illumination. In an illustrated embodiment, the maximum passage of illumination is passage of all illumination, and the minimum passage of illumination is blocking of all illumination. In an illustrated embodiment, intensity control apparatus mechanically blocks optical path 30 with one or more movable opaque plates. However, other modes of controlling illumination, such as providing in the optical path materials with electrically adjustable transmissivity of optical radiation, may be employed. Liquid crystal displays, and pairs of polarizing filters, are examples of such other modes of controlling illumination.

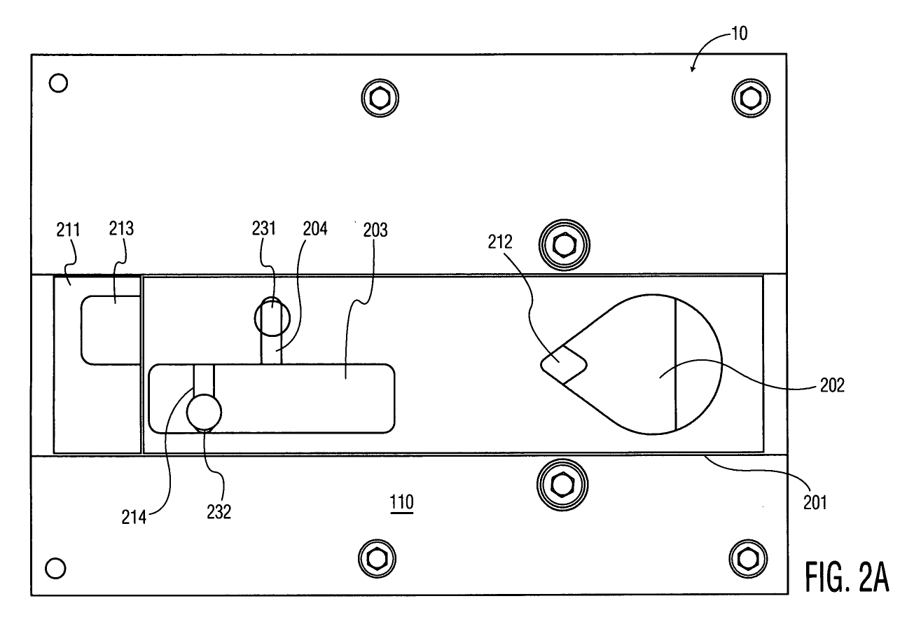

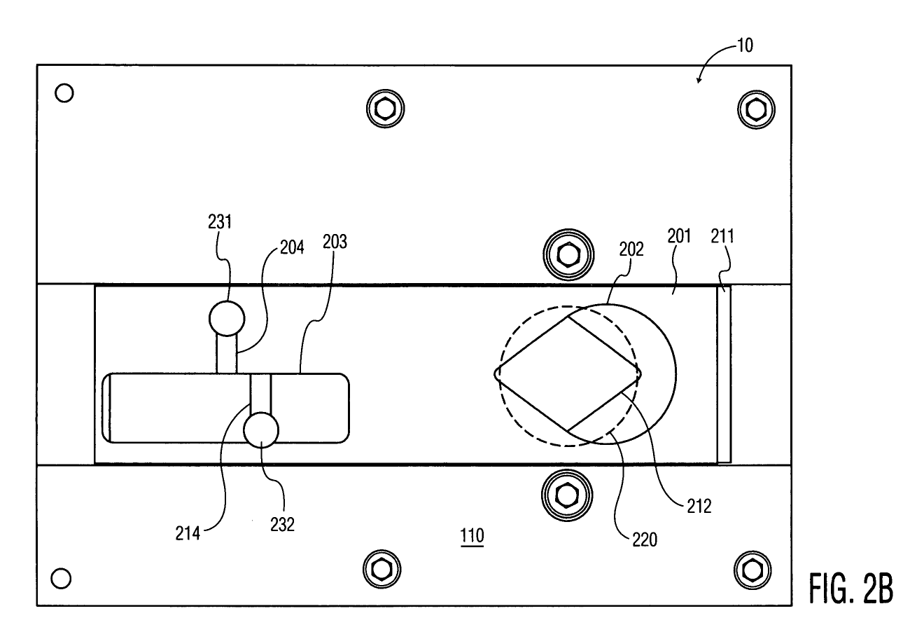

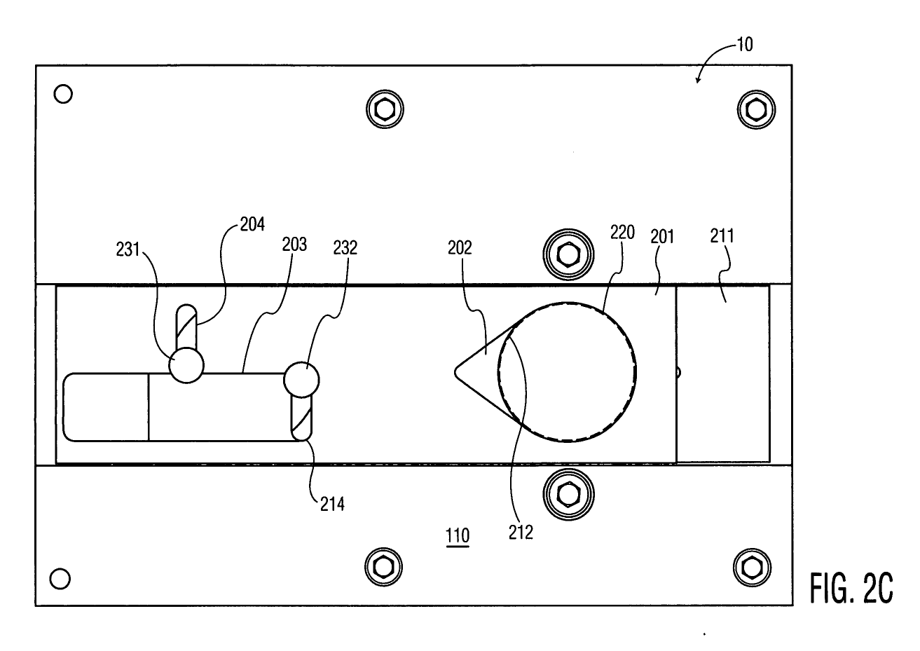

Referring to FIGS. 2A, 2B and 2C, an exemplary intensity control apparatus 10 is illustrated. Exemplary intensity control apparatus 10 has two opaque, rectangular, planar plates 201, 211, mounted in wall 110 adjacent one another and slidable along their respective long axes. Plate 201 has a substantially teardrop-shaped aperture 202 therethrough near one end thereof. Aperture 202 has a round end near an end of plate 201 and its angular end near the center of plate 201. Plate 211 has a similar aperture 212 near one end thereof, but oriented in an opposite direction. As plates 201, 211 slide relative to one another, apertures 202, 212 come into alignment. In the illustrated example, an optical path is shown by a circular beam. In FIG. 2A, apertures 202, 212 are only in alignment at their respective angular ends, and the majority of the optical path is blocked. In FIG. 2B, apertures 202, 212 are partially in alignment, and transmission of radiation is partially blocked for a beam path of the size shown in a dashed circle at 220. In FIG. 2C, the circular ends of apertures 202, 212 are aligned to provide a circular aperture for transmission of an entire beam path of a diameter up to that of the apertures 202, 212.

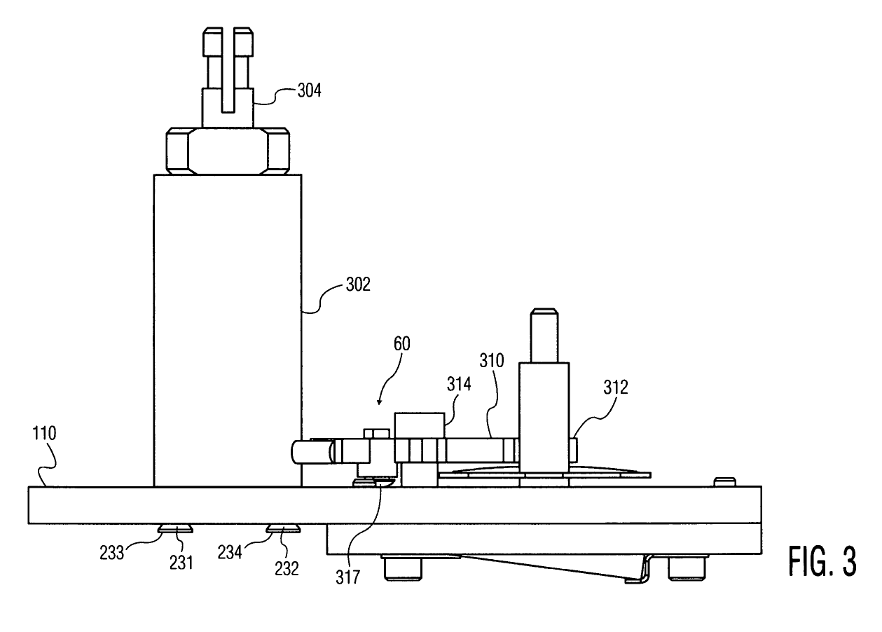

Plates 201, 211, are adapted for use where unitary mechanical user interface 50 is a rotatable knob. Plate 201 has a rectangular aperture 203, at an opposite end from aperture 202, and slot 204 extending transversely from rectangular aperture 203. Plate 211 similarly has a rectangular aperture 213, at an opposite end from aperture 212, and slot 214 extending transversely from rectangular aperture 213. Referring to FIG. 3, first and second rods, at 231, 232, are mounted on opposite sides of the axis of rotation of a knob, and are transverse to plates 201, 211. Rod 231 extends through slot 204 and rectangular aperture 213. Rod 232 extends through slot 214 and rectangular aperture 203. Rod 231 has a knob 233 on an end thereof, and rod 232 has knob 234 on an end thereof, which knobs 233, 234 have diameters larger than the diameters of respective slots 204, 214. As the rods 231, 232, rotate, they cause plates 201, 211 to move along their respective long axes. Rods 231, 232 move transversely to the long axes of the plates in slots 204, 214 move. Rods 231, 232 thus permit selective movement of plates 201, 211, to selectively control the size of the aperture in the beam path.

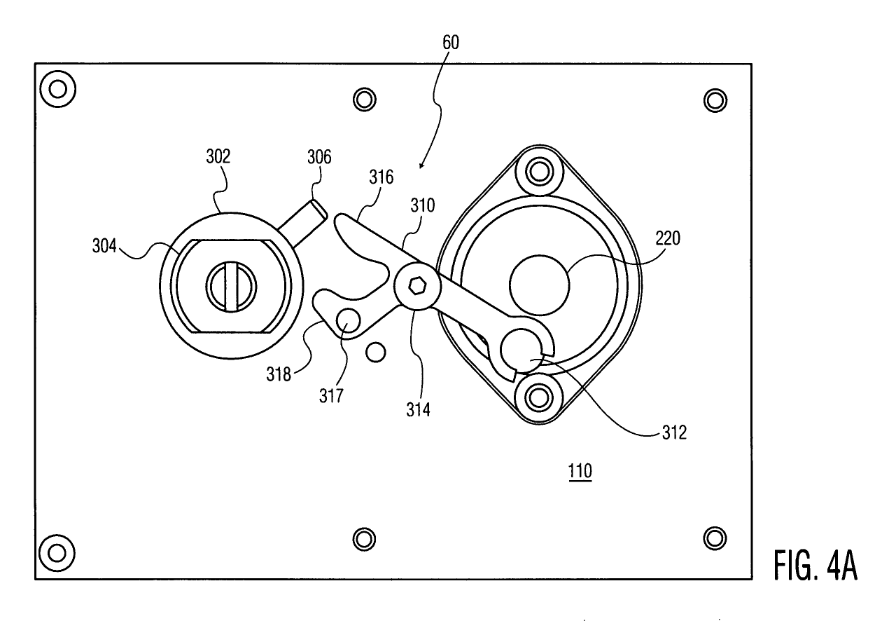

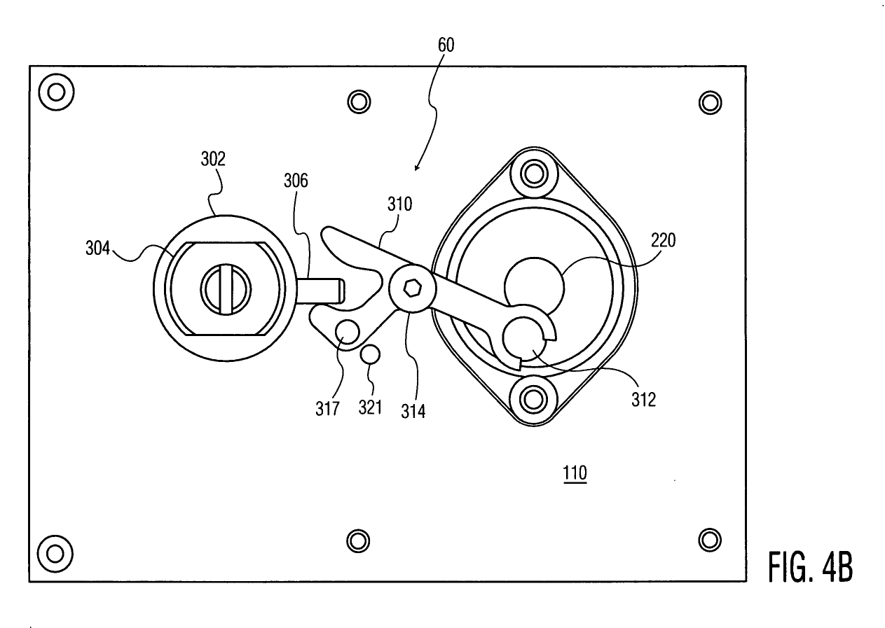

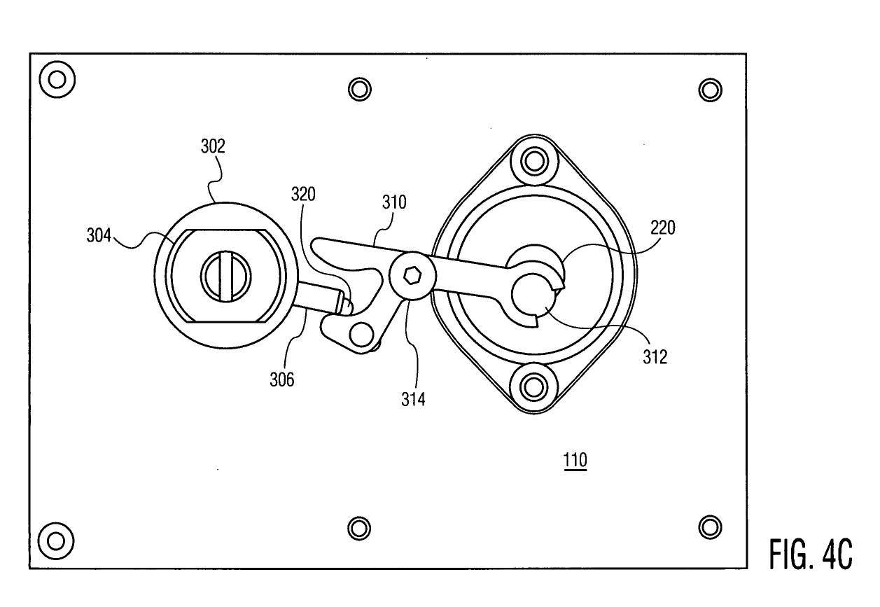

Referring now to FIG. 3, and to FIGS. 4A, 4B and 4C, an exemplary mechanism 60 for selectively disposing a filter in the optical path is illustrated. Barrel 302 is mounted to rotate, and is coupled to mount 304, on which a suitable knob may be mounted to provide unitary mechanical input 50. Rods 231, 232 project through wall 110 and are visible in FIG. 3.

Ratchet 310 carries filter 312, and is rotatably mounted on rod 314. In FIG. 4A, filter 312 is in a position other than in the optical path. Ratchet 310 is retained in this position by alignment of spring-loaded ball plunger 317 in first detent 320 (shown in FIG. 4C). Ratchet 310 has, opposite filter 312, first prong 316 and second prong 318. Spring-loaded ball plunger 317 is mounted on second prong 318. Arm 306 projects from barrel 302. Arm 306 and first prong 316 are so mounted, shaped and sized, when arm 310 is in its disengaged position, and barrel 302 is rotated, arm 306 passes first prong 316. As barrel 302 is further rotated, arm 306 contacts second prong 318. Further rotation of barrel 302 requires rotation of arm 310, which in turn requires depressing spring-loaded bearing ball plunger 317 sufficiently to clear first detent 320. Thus, continued turning of barrel 302 requires force beyond that employed in turning barrel 302 until arm 306 contacts second prong 318. The portion of the rotation of barrel 302 before arm 306 contacts second prong 318 may be referred to as a first travel portion, and the portion of the rotation of barrel 302 after arm 306 contacts second prong 316 may be referred to as a second travel portion. Greater force is required to move barrel 302 from first travel portion into the second travel portion than the force required to move barrel 302 within first travel portion. In FIG. 4B, arm 306 has been rotated sufficiently far to bring rotate ratchet 310 partly to its engaged position. As can be seen, filter 312 has been moved partially into the optical path at 220. Continued rotation of barrel 302 causes arm 306 to urge ratchet 310 rotationally, until spring-loaded ball plunger 317 reaches second detent 321 and is engaged therein. When ball plunger 317 is engaged in second detent 321, filter 312 is disposed in the optical path.

When it is desired to remove the filter 312 from the optical path, unitary mechanical interface 50 is rotated in the opposite direction to rotate barrel 302. Reversing the rotation of the barrel 302 causes arm 306 to encounter first prong 316. At this point, resistance will be encountered by the user seeking to rotate unitary mechanical interface 50, until spring-loaded ball plunger 317 is sufficiently depressed to disengage from second detent 321. Continued rotation of barrel 302 causes ratchet 310 to rotate, thereby moving filter 312 away from the optical path. Ratchet 310 continues to rotate until ball plunger 317 engages first detect 320. Arm 310 is then returned to the position shown in FIG. 4A. Continued rotation of barrel 302 causes arm 306 to continue to move, but without engaging arm 310.

An exemplary filter will filter out light with wavelengths of below about 530 nm, thereby removing lower wavelengths that will tend to cure composites. Examples of suitable filters include: Schott 0G550 glass filter. The threshold wavelength may be selected as desired by those of ordinary skill in the art. Filters adapted for other types of applications may alternatively be provided.

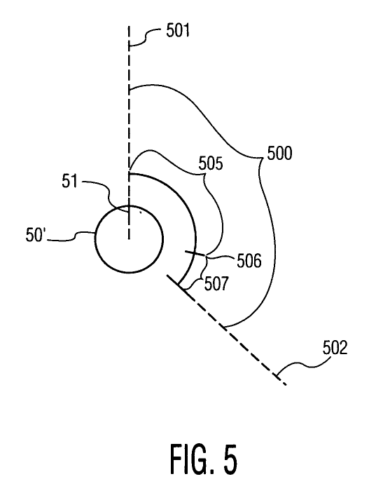

In the illustrated embodiment, unitary mechanical input 50 is in the form of a knob 50′ mounted to rotate. Referring to FIG. 5, an exemplary travel path is shown schematically. Travel path 500 shows the entire travel path of knob 50′. When the indicator 51 is at 501, the transmission of illumination is at a minimum. When knob 50′ has been rotated to place indicator 51 at 502, the transmission of illumination is at a maximum, and the filter is deployed in the optical path. First travel path portion 505 extends from minimum position 501 to intermediate position 506. Motion of knob 50′ in first travel path portion 505 results in intensity adjustment. While knob 50′ is in first travel path portion 505, the filter is not deployed in the optical path. Second travel path portion 507 extends from intermediate position 506 to maximum position 502. When the user exerts force on knob 50′ to attempt to move knob 50′ from intermediate position 506 into second travel path portion 507, resistance, or a counter force, is encountered. In the illustrated embodiment, sufficient force must be applied to force ball plunger 317 out of first detent 320. Thus, the user will not inadvertently move the filter into the optical path. Knob 50′ is then moved through second travel path portion 507 to position 502. Knob 50′ is engaged at position 502, such as by motion of ball plunger 317 into second detent 321. Thus, the user will be able to feel when the filter is in place, without having to turn to look at the light source. Removal of the filter, by movement of knob 50′ from position 502, requires overcoming a force, such as a force sufficient to move ball plunger 317 out of second detent 321. Thus, the user will not readily inadvertently remove the filter. The detent at position 506 also prevents inadvertent reduction of the light intensity.

Advantages of the invention include permitting a user, such as a dental professional, to both adjust illumination intensity of light output by a headset and interpose a filter, for filtering out lower wavelengths that will tend to cure light-curable materials prematurely, without a need to remove the user's fingers from a single mechanical control. There is no need for the user to look at the light source to find a switch, or to reach without looking for a switch.

While the foregoing invention has been described with reference to the above described embodiment, various modifications and changes can be made without departing from the spirit of the invention. Accordingly, all such modifications and changes are considered to be within the scope of the invention.

What is claimed is:

1. A device for selectively controlling illumination from a source that emits illumination along an optical path toward an output, comprising:
an intensity control apparatus for selectively controlling the intensity of illumination at the output;
a filter adapted to be selectively disposed in the optical path; and
a unitary mechanical user input operatively connected to said intensity control apparatus and to said filter, for controlling said intensity control apparatus and for, when said intensity is at a maximum, permitting selective disposition of said filter in the optical path.

2. The device of claim 1, wherein said intensity control apparatus comprises a movable plate for selectively blocking the optical path between the source and the output.

3. The device of claim 2, wherein said intensity control apparatus comprises a second movable plate.

4. The device of claim 1, wherein said filter has a first position outside said optical path and a second position in said optical path.

5. The device of claim 1, wherein said unitary mechanical user input has a travel path having first and second portions, travel in said first travel path portion controlling said intensity control apparatus, and travel in said second travel path portion selectively disposing said filter in the optical path.

6. The device of claim 5, wherein resistance attends urging of said unitary mechanical user input from said first travel path portion to said second travel path portion.

7. An apparatus for providing illumination at an output port, comprising:
a lamp for providing illumination along an optical path to an output;
an intensity control apparatus for selectively controlling the intensity of illumination at the output;
a filter adapted to be selectively disposed in the optical path; and
a unitary mechanical user input for controlling said intensity control apparatus and for, when said intensity is at a maximum, permitting selective disposition of said filter in the optical path.

8. The apparatus of claim 7, wherein said lamp is one of a metal halide bulb, a xenon bulb, a tungsten halogen bulb, or a mercury bulb.

9. The apparatus of claim 7, wherein said unitary mechanical user input comprises a rotatable knob.

10. The apparatus of claim 7, wherein said intensity control apparatus comprises a movable plate.

11. The apparatus of claim 7, wherein said filter has a first position outside said optical path and a second position in said optical path.

12. The apparatus of claim 7, wherein said unitary mechanical user input has a travel path having first and second portions, travel in said first portion controlling said intensity control apparatus, and travel in said second travel portion selectively disposing said filter in the optical path.

13. The apparatus of claim 12, wherein resistance attends urging of said unitary mechanical user input from said first travel portion to said second travel portion.

14. A device for selectively controlling illumination from a source that emits illumination along an optical path toward an output, comprising:
an opaque member movably mounted to selectively block the optical path so as to selectively control the intensity of illumination at the output;
a filter supported on a ratchet arm, said ratchet arm being movably mounted so that said filter may be selectively disposed in the optical path; and
a unitary mechanical user input operatively connected to said opaque member and said filter, for selectively moving said opaque member for controlling the intensity of illumination at the output and, when said intensity is at a maximum, permitting selective disposition of said filter in the optical path.

15. The apparatus of claim 14, wherein said opaque member comprises a substantially planar plate.

16. The apparatus of claim 14, wherein said unitary mechanical user input is rotatably mounted.

17. The apparatus of claim 14, wherein said filter is adapted to prevent transmission of light of wavelengths below about 530 nm.

18. A method for selectively controlling illumination from a source that emits illumination along an optical path toward an output, comprising the steps of:
urging a unitary mechanical user input in a first direction to adjust an intensity control apparatus to selectively control the intensity of illumination at the output; and
when said intensity is at a maximum, continuing to urge said unitary mechanical user input in said first direction to dispose said filter in the optical path.

19. The method of claim 18, wherein said step of urging said unitary mechanical user input in a first direction comprises rotating a knob in a first direction.

20. The method of claim 18, wherein said step of urging a unitary mechanical user input in a first direction to adjust an intensity control apparatus causes an opaque member to be selectively positioned in said optical path.
